(19) United States
(12) Patent Application Publication
(10) Pub. No.: US 2017/0107385 A1
(43) Pub. Date: Apr. 20, 2017

(54) ACTIVE-ENERGY-RAY-CURABLE COMPOSITION, CURED MATERIAL, COMPOSITION STORED CONTAINER, TWO-DIMENSIONAL OR THREE-DIMENSIONAL IMAGE FORMING APPARATUS, AND TWO-DIMENSIONAL OR THREE-DIMENSIONAL IMAGE FORMING METHOD

(71) Applicants: Mio KUMAI, Tokyo (JP); Mihoko Matsumoto, Shizuoka (JP); Masayuki Koyano, Kanagawa (JP); Azumi Miyaake, Kanagawa (JP); Shun Saito, Kanagawa (JP); Yuuki Mizutani, Kanagawa (JP); Hiroki Nakane, Kanagawa (JP); Shizuka Kohzuki, Kanagawa (JP)

(72) Inventors: Mio KUMAI, Tokyo (JP); Mihoko Matsumoto, Shizuoka (JP); Masayuki Koyano, Kanagawa (JP); Azumi Miyaake, Kanagawa (JP); Shun Saito, Kanagawa (JP); Yuuki Mizutani, Kanagawa (JP); Hiroki Nakane, Kanagawa (JP); Shizuka Kohzuki, Kanagawa (JP)

(21) Appl. No.: 15/271,892

(22) Filed: Sep. 21, 2016

(30) Foreign Application Priority Data
Oct. 15, 2015 (JP) 2015-203799
Jul. 22, 2016 (JP) 2016-144299

(51) Int. Cl. C09D 11/101; C09D 11/104; C09D 125/14; C09D 133/14; C09D 175/04; C09D 11/322; C09D 11/326; C09D 11/38; C09D 11/107; C09D 167/03

(52) U.S. Cl. CPC C09D 11/101; C09D 11/107; C09D 11/104; C09D 125/14; C09D 167/03; C09D 175/04; C09D 11/322; C09D 11/326; C09D 11/38; C09D 133/14

(57) ABSTRACT

An active-energy-ray-curable composition, cured material of which satisfies W1≧75.0 g and 165.0 g≦W2≦300.0 g when the material is analyzed by variable-normal-load-friction-and-wear-measurement system, W1 being expressed by W1=4*TW1 and W2 being expressed by W2=4*TW2, TW1 and TW2 being obtained by method in which: the material is formed by coating the composition on substrate to have thickness of 10 μm, and curing the composition, and in the system, load is applied to the material with indenter while the load is changed from 0 g through 200 g for 50 seconds to obtain graph having time in horizontal axis and friction resistance force in vertical axis, and in the graph, a time at which scratch first occurs in the material is defined as T1 and time closest to T1 among times at which change in the friction resistance force is discontinuous is defined as TW1; and TW2 is defined as time at which the substrate is exposed.

### CROSS-REFERENCE TO RELATED APPLICATIONS

The present application claims priority under 35 U.S.C. §119 to Japanese Patent Application No. 2015-203799, filed Oct. 15, 2015 and Japanese Patent Application No. 2016-144299, filed Jul. 22, 2016. The contents of which are incorporated herein by reference in their entirety.

### BACKGROUND OF THE INVENTION

Field of the Invention

The present disclosure relates to an active-energy-ray-curable composition, a cured material, a composition stored container, a two-dimensional or three-dimensional image forming apparatus, and a two-dimensional or three-dimensional image forming method.

Description of the Related Art

Hitherto, photopolymerizable inks have been supplied and used for offset printing, screen printing, and top coating agents. In recent years, an amount of the photopolymerizable inks used has increased because there are advantages that a process of drying the ink can be simplified to result in cost saving and an amount of solvent volatilized can be reduced to attain environmental friendliness.

As inkjet inks, many aqueous inkjet inks and solvent inkjet inks have been used and have found different applications depending on the properties. However, the aqueous inkjet inks and the solvent inkjet inks have the following problems, for example: ink-receiving substrates usable for industrial applications (e.g., members to be coated with inks and media to be printed) are limited; the inks have relatively poor water resistance; drying energy of the inks is large; and ink components are attached to heads due to drying. Therefore, it has been considered that the aqueous inkjet inks and the solvent inkjet inks are replaced with photopolymerizable inks having a relatively low volatility.

In recent years, there has increasingly been a demand that a photopolymerizable inkjet ink printed on a substrate be subjected to molding process as post process. Because the printed portion covers the outermost surface of the molded product, the photopolymerizable inkjet ink is required to have scratch resistance and dent resistance. Moreover, it is also important for the photopolymerizable inkjet ink to have high close adhesiveness to the substrate. In order to secure the scratch resistance and the dent resistance, it is necessary to secure high hardness.

In general, the inkjet inks include polymerizable monofunctional monomers. However, sufficient hardness of the inkjet inks cannot be obtained by simply incorporating monofunctional monomers. It is generally well known that hardness is expected to increase by incorporation of polymerizable multifunctional monomers. However, rigidity of the printed portion becomes higher with increasing of the hardness. As a result, it becomes difficult for the printed portion to follow the substrate. This leads to deterioration in close adhesiveness.

As described above, the hardness and the close adhesiveness are always in a trade-off relationship. The existing techniques cannot achieve both hardness and close adhesiveness at high levels.

Japanese Patent Nos. 4335955 and 5689614 attempt to achieve both satisfactory curing ability and satisfactory close adhesiveness. However, it cannot be said that these are satisfactory. In particular, regarding the curing ability, durability to strong force is secured but there is no reference to durability to weak force. Each of the above cannot achieve the targeted hardness and the targeted close adhesiveness, which is problematic.

### SUMMARY OF THE INVENTION

According to one aspect of the present disclosure, an active-energy-ray-curable composition is such that a cured material of the active-energy-ray-curable composition satisfies W1 of 75.0 g or more and W2 of 165.0 g or more but 300.0 g or less when the cured material is analyzed by a variable normal load friction and wear measurement system. The W1 is expressed by W1=4*TW1. The W2 is expressed by W2=4*TW2. The TW1 and the TW2 are obtained by a method described below.

### (Measurement Method)

The cured material is formed by coating the active-energy-ray-curable composition on a substrate so as to have a thickness of 10 μm, and by curing the active-energy-ray-curable composition.

In the variable normal load friction and wear measurement system, a load is applied to the cured material with an indenter while the load is changed from 0 g through 200 g for 50 seconds to obtain a graph having a time in a horizontal axis and a friction resistance force in a vertical axis. In the graph obtained, a time at which a scratch first occurs in the cured material is defined as T1 and a time closest to the T1 among times at which a change in the friction resistance force is discontinuous is defined as the TW1.

The TW2 is defined as a time at which the substrate is exposed.

### BRIEF DESCRIPTION OF THE DRAWINGS

FIG. 1 is a schematic view of an example of an image forming apparatus of the present disclosure;

FIG. 2 is a schematic view of an example of another image forming apparatus of the present disclosure;

FIG. 3A is a schematic view of an example of still another image forming apparatus of the present disclosure;

FIG. 3B is a schematic view of an example of still another image forming apparatus of the present disclosure;

FIG. 3C is a schematic view of an example of still another image forming apparatus of the present disclosure;

FIG. 3D is a schematic view of an example of still another image forming apparatus of the present disclosure;

FIG. 4 is one example of a graph obtained by a variable normal load friction and wear measurement system;

FIG. 5 is another example of a graph obtained by a variable normal load friction and wear measurement system;

FIG. 6 is still another example of a graph obtained by a variable normal load friction and wear measurement system;

FIG. 7A is a graph for presenting a method for determining TW1 in a graph obtained by a variable normal load friction and wear measurement system;

FIG. 7B is a graph for presenting a method for determining TW1 in a graph obtained by a variable normal load friction and wear measurement system;

FIG. 8 is a schematic view of a main part of one example of a flow tester device; and

FIG. 9 is a view for presenting a method for determining TP.

### DESCRIPTION OF THE EMBODIMENTS

Hereinafter, an active-energy-ray-curable composition, a composition stored container, an image forming apparatus, an image forming method, and a cured material according to the present disclosure will be described with reference to the drawings. Note that, the present disclosure is not limited to the below-described embodiments, and can be altered within a conceivable scope of persons skilled in the art. For example, other embodiments, additions, modifications, or deletions may be made. Any aspect should be within the scope of the present disclosure so long as actions and effects of the present disclosure are realized.

In the present disclosure, a cured material of an active-energy-ray-curable composition satisfies W1 of 75.0 g or more and W2 of 165.0 g or more but 300.0 g or less when the cured material is analyzed by a variable normal load friction and wear measurement system (TYPE: HHS2000, available from Shinto Scientific Co., Ltd.). The W1 is expressed by W1=4*TW1. The W2 is expressed by W2=4*TW2. The TW1 and the TW2 are obtained by a method described below.

A relationship between the W1 and the W2 is always W1≦W2 regardless of ink formulations.

### (Measurement Method)

The cured material is formed by coating the active-energy-ray-curable composition on a substrate so as to have a thickness of 10 μm, and by curing the active-energy-ray-curable composition.

In the variable normal load friction and wear measurement system, a load is applied to the cured material with an indenter while the load is changed from 0 g through 200 g for 50 seconds to obtain a graph having a time in a horizontal axis and a friction resistance force in a vertical axis. In the graph obtained, a time at which a scratch first occurs in the cured material is defined as T1 and a time the closest to the T1 among times at which a change in the friction resistance force is discontinuous is defined as the TW1.

The TW2 is defined as a time at which the substrate is exposed.

The present disclosure has an object to provide an active-energy-ray-curable composition, a cured material of which is excellent in scratch hardness and indentation hardness and having high close adhesiveness to a substrate.

According to the present disclosure, it is possible to provide an active-energy-ray-curable composition, a cured material of which is excellent in scratch hardness and indentation hardness and having high close adhesiveness to a substrate.

### (Physical Property)

As a result of the studies diligently performed by the present inventors to achieve the aforementioned object, it is found that when a cured material of an active-energy-ray-curable composition is analyzed by a variable normal load friction and wear measurement system, use of the active-energy-ray-curable composition that satisfies W1 and W2 falling within the above preferable ranges makes it possible to obtain the cured material having high hardness and being excellent in close adhesiveness. The above mechanism has currently been investigated, but is assumed as described below from several analysis data.

In the active-energy-ray-curable composition, a value of W1, which is obtained by analyzing a cured material of the active-energy-ray-curable composition by the variable normal load friction and wear measurement system, is a parameter indicating scratch hardness of the surface of the cured material. It is believed that the higher the value of W1 is, the higher the scratch hardness of the surface of the cured material is and that the lower the value of W1 is, the lower the scratch hardness of the surface of the cured material is.

In the present disclosure, the value of W1 is 75.0 g or more, preferably 100.0 g or more, more preferably 140.0 g or more, and also the value of W1 is equal to or less than the value of W2. The value of W1 being 100.0 g or more is preferable because the surface of the cured material has sufficient scratch hardness and is hardly damaged through scratching. Examples of the method for increasing the value of W1 include methods such as using a polymerization initiator excellent in surface-curing ability and adding silica particles.

A value of W2, which is obtained by analyzing the cured material by the variable normal load friction and wear measurement system, is a parameter indicating flexibility of the inside of the cured material. The smaller the value of W2 is, the lower the flexibility of the inside of the cured material is. The higher the value of W2 is, the higher the flexibility of the inside of the cured material is. An upper limit of the W2 is 300.0 g or less, preferably 280.0 g or less. The upper limit of the W2 being 280.0 g or less is preferable because the inside of the cured material exhibits low flexibility and is hardly damaged through indentation.

On the other hand, a lower limit of the W2 is 165.0 g or more, preferably 200.0 g or more. The lower limit of the W2 being 200.0 g or more is preferable because the inside of the cured material has sufficient flexibility and thus has high close adhesiveness.

Therefore, the value of W2 being 200.0 g or more but 280.0 g or less is preferable because the active-energy-ray-curable composition can achieve both being hardly damaged through indentation and close adhesiveness.

Examples of a method for changing the value of W2 include a method of changing an amount of the multifunctional monomer and a method of changing an amount of the oligomer. In the present disclosure, the cured material mainly prepared on a glass slide (substrate) is mainly described. Therefore, strictly speaking, the present disclosure will refer to close adhesiveness to a glass slide. However, the close adhesiveness of the active-energy-ray-curable composition presented in the present disclosure is not secured by a chemical force (e.g., by adjusting the formulation of the active-energy-ray-curable composition so as to be similar to the formulation of the substrate) but is secured by a physical force by increasing the active-energy-ray-curable composition in flexibility. Therefore, the active-energy-ray-curable composition is highly likely to exhibit high close adhesiveness to substrates other than the glass slide. Moreover, even if active-energy-ray-curable compositions to be used have greatly different formulations, corresponding cured materials can be formed on a glass slide in the same manner as described above and be evaluated for close adhesiveness with arranged laterally.

### <Method for Determining W1 and W2 by Variable Normal Load Friction and Wear Measurement System>

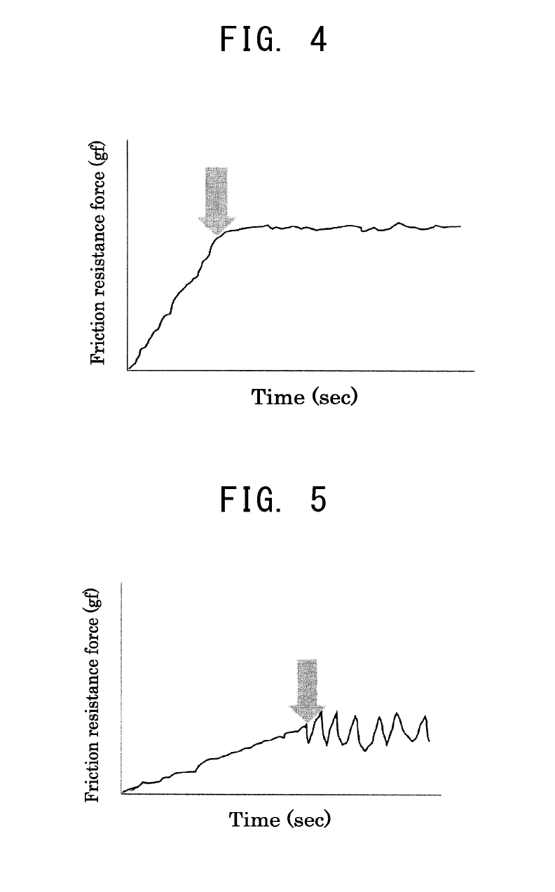

In the present disclosure, physical properties of the active-energy-ray-curable composition are defined by the W1 and the W2 obtained by the variable normal load friction and wear measurement system. Analysis is performed in the following manner. Analysis methods will be described with reference to FIGS. 4 to 7.

A variable normal load friction and wear measurement system, TYPE: HHS2000 (HEIDON, available from Shinto Scientific Co., Ltd.) is used for evaluation. This device is used in a method for calculating a friction resistance force against each load by scratching the active-energy-ray-curable composition with an indenter while the load is gradually increased. A graph having a friction resistance force (unit: gf) in a vertical axis and a time (unit: sec) or load (unit: g) in a horizontal axis can be obtained. Details will be described below.

### (1) Sample

The active-energy-ray-curable composition is coated on a glass slide (available from Artec Co., Ltd., 008534, 26×76 mm, thickness: from 1 mm through 1.2 mm) so as to have a film thickness of 10 mi. Immediately after the coating, the active-energy-ray-curable composition is irradiated with ultraviolet rays (illuminance: 1.5 W/cm², light quantity: 200 mJ/cm²) by an UV irradiator LH6 (available from Fusion Systems Japan) to obtain a cured material.

### (2) Measurement Conditions

Indenter: Sapphire stylus, 0.2 mm R 60 degrees

Friction distance: 25 mm

Friction speed: 0.5 mm/sec

Continuous loading: From 0 g through 200 g

Number of measurements: Measured twice at different positions

Loading converter (friction): 19.61 N (2,000 gf) . . . 5,000 mV=2,000 gf

PC data acquisition: 10 msec×5,000 data=50 sec

When the above conditions are employed, the W1 and the W2 can be calculated at the same time in one measurement.

### (3) Method for Determining W1

A CCD camera is used to take a video of a state of a continuous loading test. A time when a scratch first occurs (T1) is measured. When the entire measurement has been completed, a graph having a friction resistance force (unit: in a vertical axis and a time (unit: sec) in a horizontal axis can be obtained.

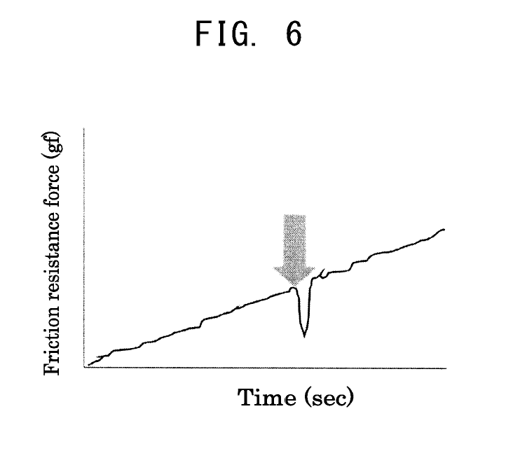

Examples of the graph are presented in FIGS. 4 to 6. When graphs are obtained with a friction resistance force in a vertical axis and a time in a horizontal axis, change of the gradient and others appear as indicated by the arrows of FIGS. 4 to 6. In FIG. 4, change of the gradient appears at the portion indicated by the arrow in the graph. In FIG. 5, change of the amplitude appears at the portion indicated by the arrow in the graph. In FIG. 6, the gradient is once changed and then is returned to the original gradient. The difference in level appears at the portion indicated by the arrow in the graph.

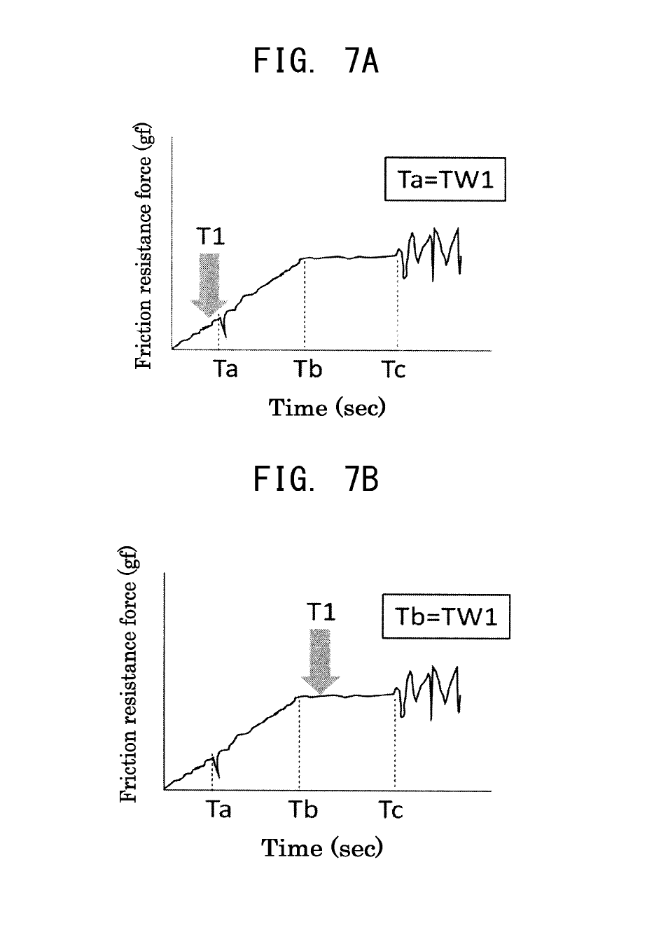

As presented in FIGS. 7A and 7B, all of the discontinuities (change of the gradient (FIG. 4), change of the amplitude of a waveform (FIG. 5), and difference in level (FIG. 6)) are extracted from the obtained graph. A time at the point of the change of the gradient, a time at the point of the change of the amplitude, and a time at the point of the difference in level are respectively defined as Ta, Tb, Tc, . . . (FIGS. 7A and 7B). Here, among the Ta, the Tb, the Tc, . . . , a time the closest to the T1 is defined as TW1. For example, in FIG. 7A, a time the closest to the T1 is Ta and thus the Ta is defined as the TW1. In FIG. 7B, a time the closest to the T1 is Tb and thus the Tb is defined as the TW1. The obtained TW1 is used for calculating W1 in the following Formula (1).

W1=4*TW1 (1)

In the above Formula (1), W1 is obtained by multiplying TW1 with 4 based on the measurement conditions that the load (200 g) is applied to the sample for 50 seconds. The measurement is performed twice and an average of the obtained two values is used.

### (4) Method for Determining W2

A CCD camera is used to take a video of a state of a continuous loading test. A time at which the substrate (glass slide) is first exposed (TW2) is measured. The obtained TW2 is used for calculating W2 in the following Formula (2).

W2=4*TW2 (2)

In the above Formula (2), W2 is obtained in the same manner as in the Formula (1) by multiplying TW2 with 4 based on the measurement conditions that the load (200 g) is applied to the sample for 50 seconds. The measurement is performed twice and an average of the obtained two values is used.

The W1 and the W2 always satisfy the following relationship: W1≦W2. The W1 and the W2 are in a relationship of W1=W2 when a scratch does not occur at all in a low-loaded region and the substrate and the cured material are suddenly broken at a certain load.

Here, when the measurement is performed as described above, a breakdown of the film results in appearance of the change of the gradient of the graph, the change of the amplitude, and the difference in level. However, patterns of these are different depending on various factors such as the formulation of the cured material. In addition, these changes may appear due to existence of only a small amount of dust attached to the surface of the film. Therefore, the measurement is observed with the CCD camera so as to avoid recording a change that is different from the intended change.

In the obtained graph, the description “a change in the friction resistance force is discontinuous” means that a value of a vertical axis value/a value of a horizontal axis; i.e., friction resistance force/time, deviates from a certain value. This is a state where there are change of the gradient of the graph, change of the amplitude, and difference in level as described above.

### <Quantitative Determination of Each Component Included in Active-Energy-Ray-Curable Composition>

Examples of methods for determining the quantities of the non-polymerizable resin, the polymerization initiator, the monofunctional monomer including one polymerizable, ethylenically-unsaturated double bond, the multifunctional monomer including two or more polymerizable, ethylenically-unsaturated double bonds, the oligomer including a polymerizable, ethylenically-unsaturated double bond, and the silica particles included in the active-energy-ray-curable composition include: a method of determining the quantity from a peak intensity obtained through GC-MS measurement; a method of determining the quantity from a peak intensity of a molecular weight distribution measurement obtained through gel permeation chromatography (GPC); and a method of determining the quantity from an integrated value obtained through ¹H NMR measurement.

When the kind of each component is unknown, qualitative analysis is performed in advance by, for example, GC-MS or ¹H NMR. One specific quantitative method is a method including preparing a calibration curve. In a convenient manner, a standard sample for each component (e.g., a sample including 15% by mass of a multifunctional monomer to be measured) is prepared and measured under the same conditions, which makes it possible to relatively evaluate whether the amount of the component is larger or smaller. When an amount of each component in the production of the active-energy-ray-curable composition is already known, that amount is defined as an amount of each component.

### <Thermal Property TP>

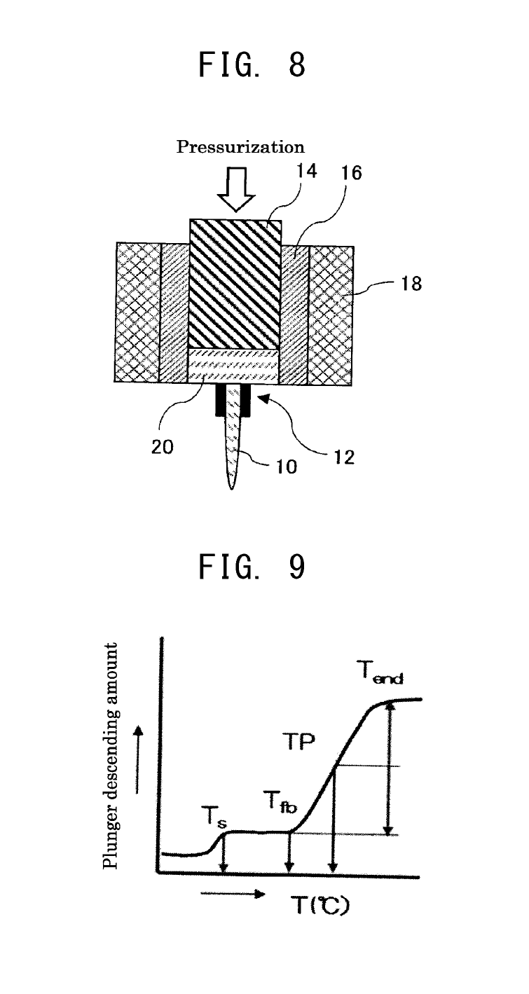

The non-polymerizable resin of the present disclosure is measured and evaluated for the thermal property TP using a flow tester device as presented in FIG. 8. Examples of the flow tester device include flow tester CFT-500D (available from SHIMADZU CORPORATION). Measurement examples will be described below.

### [Measurement Conditions]

Sample: A sample (1 g) is pressure-molded into a cylindrical tablet having a diameter of 1 cm for use.
Temperature conditions: The sample is heated from 50° C. at a heating rate of 3° C./min to a temperature at which flow-out of the sample has been completed.
Load: 10 kg
Hole diameter of die: 0.5 mm
Length of die: 1.0 mm
Remaining heat time: 200 s

In the device, a resin sample 20 that has been molded into the tablet in a cylinder 16 is heated with a heating member 18, while a load is applied with a plunger 14. Then, the melted resin (melted and flown-out resin 10) is allowed to flow out from a die hole (nozzle 12). At this time, a descending amount of the plunger 14 is measured and evaluated for viscoelasticity (temperature dependency) of the resin.

One example of the obtained graph is presented in FIG. 9. Near glass transition of the resin, there is a temperature at which the melted resin begins to move in response to the heating although the melted resin does not flow out. This temperature is defined as softening temperature Ts. A temperature at which the descending amount greatly changes to lead to completion of flowing-out of the melted resin is typically defined as flowing-out beginning temperature Tfb. A temperature at which the flowing-out has been completed is defined as Tend. In the present disclosure, a middle temperature between the flowing-out beginning temperature Tfb and the Tend ((Tfb+Tend)/2) is defined as TP.

### (Composition)

An active-energy-ray-curable composition of the present disclosure preferably includes a non-polymerizable resin, a monofunctional monomer including one polymerizable, ethylenically-unsaturated double bond, a multifunctional monomer including two or more polymerizable, ethylenically-unsaturated double bonds, a polymerization initiator, and active silica particles, and if necessary, preferably includes an oligomer including a polymerizable, ethylenically-unsaturated double bond. Moreover, the active-energy-ray-curable composition of the present disclosure may include a colorant, an organic solvent, and other components. Details will be described below.

### <Monofunctional Monomer>

In the present disclosure, the monofunctional monomer means a monomer including one polymerizable, ethylenically-unsaturated double bond. Incorporation of the monofunctional monomer including one polymerizable, ethylenically-unsaturated double bond and the below-described polymerization initiator is preferable because of achievement of increased close adhesiveness.

Examples of the monofunctional monomer including one polymerizable, ethylenically-unsaturated double bond include, but are not limited to, phenoxyethyl (meth)acrylate, tetrahydrofurfuryl (meth)acrylate, isobornyl (meth)acrylate, 2-hydroxyethyl (meth)acrylate, 4-hydroxybutyl (meth)acrylate, isobutyl (meth)acrylate, t-butyl (meth)acrylate, isooctyl (meth)acrylate, 2-methoxyethyl (meth)acrylate, methoxytriethylene glycol (meth)acrylate, 2-ethoxyethyl (meth)acrylate, 3-methoxybutyl(meth)acrylate, ethoxyethyl (meth)acrylate, butoxyethyl (meth)acrylate, ethoxydiethylene glycol (meth)acrylate, ethoxydiethylene glycol (meth)acrylate, methoxydixylethyl (meth)acrylate, ethyl diglycol (meth)acrylate, cyclic trimethylolpropane formal mono(meth)acrylate, imide (meth)acrylate, isoamyl (meth)acrylate, ethoxylated succinic acid (meth) acrylate, trifluoroethyl (meth)acrylate, ω-carboxypolycaprolactone mono(meth)acrylate, N-vinylformamide, cyclohexyl (meth) acrylate, benzyl (meth)acrylate, methylphenoxyethyl (meth)acrylate, 4-t-butylcyclohexyl (meth)acrylate, caprolactone-modified tetrahydrofurfuryl (meth)acrylate, tribromophenyl (meth)acrylate, ethoxylated tribromophenyl (meth)acrylate, 2-phenoxyethyl (meth)acrylate, (meth)acryloyl morpholine, phenoxydiethylene glycol (meth)acrylate, vinylcaprolactam, vinylpyrrolidone, 2-hydroxy-3-phenoxypropyl (meth)acrylate, 1,4-cyclohexanedimethanol mono(meth)acrylate, 2-(2-ethoxyethoxy)ethyl (meth)acrylate, stearyl (meth)acrylate, diethylene glycol monobutyl ether (meth)acrylate, lauryl (meth)acrylate, isodecyl (meth)acrylate, 3,3,5-trimethylcyclohexanol (meth)acrylate, isooctyl (meth)acrylate, octyl/decyl (meth)acrylate, tridecyl (meth)acrylate, caprolactone (meth)acrylate, ethoxylated (4) nonylphenol (meth)acrylate, methoxy polyethylene glycol (350) mono(meth)acrylate, methoxy polyethylene glycol (550) mono(meth)acrylate, ethyl (meth)acrylate (ethyl acrylate), and adamantyl(meth)acrylate. These monofunctional monomers may be used in combination if necessary.

An amount of the monomer including one polymerizable, ethylenically-unsaturated double bond is not particularly limited and may be appropriately changed, but is preferably 45% by mass or more but 90% by mass or less relative to the total amount of the active-energy-ray-curable composition.

### <Multifunctional Monomer>

In the present disclosure, the multifunctional monomer means a monomer including two or more polymerizable, ethylenically-unsaturated double bonds. Incorporation of the multifunctional monomer including two or more polymerizable, ethylenically-unsaturated double bonds is preferably because of achievement of increased indentation hardness.

Examples of the multifunctional monomer used in the present disclosure include, but are not limited to, hexadiol di(meth)acrylate, trimethylolpropane tri(meth)acrylate, pentaerythritol tri(meth)acrylate, polyethylene glycol di(meth)acrylate, dipropylene glycol di(meth)acrylate, tripropylene glycol tri(meth)acrylate, neopentyl glycol di(meth)acrylate, bispentaerythritol hexa(meth)acrylate, ethylene glycol di(meth)acrylate, diethylene glycol di(meth)acrylate, 1,6-hexanediol di(meth)acrylate, ethoxylated 1,6-hexanediol di(meth)acrylate, polypropylene glycol di(meth)acrylate, 1,4-butanediol di(meth)acrylate, 1,9-nonanediol di(meth)acrylate, tetraethylene glycol di(meth)acrylate, 2-n-butyl-2-ethyl 1,3-propanediol di(meth)acrylate, hydroxypivalic acid neopentyl glycol di(meth)acrylate, 1,3-butylene glycol di(meth)acrylate, trimethylolpropane tri(meth)acrylate, hydroxypivalic acid trimethylolpropane tri(meth)acrylate, ethoxylated phosphoric acid tri(meth)acrylate, ethoxylated tripropylene glycol di(meth)acrylate, neopentyl glycol-modified trimethylolpropane di(meth)acrylate, stearic acid-modified pentaerythritol di(meth)acrylate, pentaerythritol tri(meth)acrylate, tetramethylolpropane tri(meth)acrylate, tetramethylolmethane tri(meth)acrylate, pentaerythritol tetra(meth)acrylate, caprolactone-modified trimethylolpropane tri(meth)acrylate, propoxylate glyceryl tri(meth)acrylate, tetramethylolmethane tetra(meth)acrylate, pentaerythritol tetra(meth)acrylate, ditrimethylolpropane tetra(meth)acrylate, ethoxylated pentaerythritol tetra(meth)acrylate, dipentaerythritol hexa(meth)acrylate, caprolactone-modified dipentaerythritol hexa(meth)acrylate, dipentaerythritol hydroxypenta(meth)acrylate, neopentyl glycol oligo(meth)acrylate, 1,4-butanediol oligo(meth)acrylate, 1,6-hexanediol oligo(meth)acrylate, trimethylolpropane oligo(meth)acrylate, pentaerythritol oligo(meth)acrylate, ethoxylated neopentyl glycol di(meth)acrylate, propoxylated neopentyl glycol di(meth)acrylate, tripropylene glycol di(meth)acrylate, ethoxylated trimethylolpropane tri(meth)acrylate, and propoxylated trimethylolpropane tri(meth)acrylate.

These multifunctional monomers may be used in combination if necessary.

An amount of the multifunctional monomer including two or more polymerizable, ethylenically-unsaturated double bonds is 5% by mass or more but 15% by mass or less relative to the total amount of the active-energy-ray-curable composition. When the amount of the monomer including two or more polymerizable, ethylenically-unsaturated double bonds is 10% by mass or more but 15% by mass or less, the active-energy-ray-curable composition preferably includes an oligomer including a polymerizable, ethylenically-unsaturated double bond. In this case, an amount of the oligomer including a polymerizable, ethylenically-unsaturated double bond is preferably 3% by mass or more but 9% by mass or less relative to the total amount of the active-energy-ray-curable composition. The active-energy-ray-curable composition including the multifunctional monomer and the oligomer can secure both close adhesiveness and indentation hardness of the cured material of the active-energy-ray-curable composition because the multifunctional monomer improves the active-energy-ray-curable composition in indentation hardness and the oligomer improves the active-energy-ray-curable composition in close adhesiveness.

### <Oligomer>

Examples of the oligomer used in the present disclosure include oligomers including a polymerizable, ethylenically-unsaturated double bond. Specific examples of the oligomer include aromatic urethane oligomers, aliphatic urethane oligomers, epoxy acrylate oligomers, polyester acrylate oligomers, and other special oligomers. Incorporation of the oligomer including a polymerizable, ethylenically-unsaturated double bond can improve the active-energy-ray-curable composition in close adhesiveness.

Examples of commercially available products of the oligomer include the following: UV-2000B, UV-2750B, UV-3000B, UV-3010B, UV-3200B, UV-3300B, UV-3700B, UV-6640B, UV-8630B, UV-7000B, UV-7610B, UV-1700B, UV-7630B, UV-6300B, UV-6640B, UV-7550B, UV-7600B, UV-7605B, UV-7610B, UV-7630B, UV-7640B, UV-7650B, UT-5449, and UT-5454 (available from The Nippon Synthetic Chemical Industry Co., Ltd.); CN902, CN902J75, CN929, CN940, CN944, CN944B85, CN959, CN961E75, CN961H81, CN962, CN963, CN963A80, CN963B80, CN963E75, CN963E80, CN963J85, CN964, CN965, CN965A80, CN966, CN966A80, CN966B85, CN966H90, CN966J75, CN968, CN969, CN970, CN970A60, CN970E60, CN971, CN971A80, CN971J75, CN972, CN973, CN973A80, CN973H85, CN973J75, CN975, CN977, CN977C70, CN978, CN980, CN981, CN981A75, CN981B88, CN982, CN982A75, CN982B88, CN982E75, CN983, CN984, CN985, CN985B88, CN986, CN989, CN991, CN992, CN994, CN996, CN997, CN999, CN9001, CN9002, CN9004, CN9005, CN9006, CN9007, CN9008, CN9009, CN9010, CN9011, CN9013, CN9018, CN9019, CN9024, CN9025, CN9026, CN9028, CN9029, CN9030, CN9060, CN9165, CN9167, CN9178, CN9290, CN9782, CN9783, CN9788, and CN9893 (available from Sartomer Co.); and EBECRYL 210, EBECRYL 220, EBECRYL 230, EBECRYL 270, KRM 8200, EBECRYL 5129, EBECRYL 8210, EBECRYL 8301, EBECRYL 8804, EBECRYL 8807, EBECRYL 9260, KRM 7735, KRM 8296, KRM 8452, EBECRYL 4858, EBECRYL 8402, EBECRYL 9270, EBECRYL 8311, and EBECRYL 8701 (available from DAICEL-CYTEC Co., Ltd.). These can be used in combination. Instead of the commercially available products of the oligomer, it is also possible to use oligomers that are obtained through synthesis and to use these in combination.

Among the above oligomers, the oligomers including 2 through 5 unsaturated carbon-carbon bonds are preferable. Moreover, the oligomers including 2 unsaturated carbon-carbon bonds are most preferable. The oligomers including 2 unsaturated carbon-carbon bonds can provide good drawability.

An amount of the multifunctional monomer including two or more polymerizable, ethylenically-unsaturated double bonds is 5% by mass or more but 15% by mass or less relative to the total amount of the active-energy-ray-curable composition. When the amount of the multifunctional monomer including two or more polymerizable, ethylenically-unsaturated double bonds is 10% by mass or more but 15% by mass or less, the active-energy-ray-curable composition preferably includes the oligomer including a polymerizable, ethylenically-unsaturated double bond. In this case, an amount of the oligomer including a polymerizable, ethylenically-unsaturated double bond is preferably 3% by mass or more but 9% by mass or less relative to the total amount of the active-energy-ray-curable composition. The active-energy-ray-curable composition including the multifunctional monomer and the oligomer can secure both close adhesiveness and indentation hardness of the cured material of the active-energy-ray-curable composition because the multifunctional monomer improves the cured material in indentation hardness and the oligomer improves the cured material in close adhesiveness.

### <Non-Polymerizable Resin>

As the resin used in the present disclosure, a non-polymerizable resin including no polymerizable, ethylenically-unsaturated double bond is preferably used. Incorporation of the non-polymerizable resin makes it possible to increase indentation hardness of the cured material.

Examples of the non-polymerizable resin include the following: polymers selected from acrylic resins, polyester resins, polyurethane resins, PVC resins, ketone resins, epoxy resins, nitrocellulose resins, phenoxy resins, and the mixtures of these resins.

Specific examples of the acrylic resins include JONCRYL (available from JHONSON POLYMER), S-LEC P (available from SEKISUI CHEMICAL CO., LTD.), and ELVACITE 4026 and ELVACITE 2028 (available from Lucite International, Inc). Specific examples of the polyester resins include ELITEL (available from Unitika Limited.) and VYLON (available from TOYOBO CO., LTD.). Specific examples of the polyurethane resins include VYLONUR (available from TOYOBO CO., LTD.), NT-HILAMIC (available from Dainichiseika Color & Chemicals Mfg. Co., Ltd.), CRISVON (available from DIC Corporation), and NIPPOLAN (available from Nippon Polyurethane Industry Co., Ltd.). Examples of the PVC resins include SOLBIN (available from Nissin Chemical Industry Co., Ltd.), VINYBLAN (available from Nissin Chemical Industry Co., Ltd.), SARAN LATEX (available from Asahi Kasei Chemicals Corp.), SUMIELITE (available from Sumitomo Chemical Company, Limited), SEKISUI PVC (available from SEKISUI CHEMICAL CO., LTD.), and UCAR (available from The Dow Chemical Company). Specific examples of the ketone resins include HIGH RACK (available from Hitachi Chemical Company, Ltd.) and SK (available from Degussa). Specific examples of the epoxy resins include EPPN-201 (available from Nippon Kayaku Co., Ltd.) and HP-7200 (available from DIC). Specific examples of the nitrocellulose resins include HIG, LIG, SL, and VX (available from Asahi Kasei Corp.) and industrial nitrocellulose series RS and SS (available from Daicel Chemical Industries, Ltd.). Specific examples of the phenoxy resins include YP-50 and YP-50S (available from NIPPON STEEL & SUMIKIN CHEMICAL CO., LTD.).

Instead of the commercially available products of the oligomer, it is also possible to use non-polymerizable resins that are obtained through synthesis and to use these in combination. When the non-polymerizable resin is obtained through synthesis, a material including a polymerizable, ethylenically-unsaturated double bond may be used as a starting material for the synthesis.

A thermal property TP (° C.) of the non-polymerizable resin is preferably 70° C. or more but 130° C. or less, more preferably 70° C. or more but 110° C. or less, still more preferably 70° C. or more but 90° C. or less. When the thermal property TP falls within the above preferable range, the cured material can secure close adhesiveness while retaining indentation hardness.

An amount of the non-polymerizable resin is preferably 1% by mass or more but 10% by mass or less relative to the total amount of the active-energy-ray-curable composition.

### <Active Energy Rays>

Active energy rays used for curing an active-energy-ray-curable composition of the present disclosure are not particularly limited, so long as they are able to give necessary energy for allowing polymerization reaction of polymerizable components in the composition to proceed. Examples of the active energy rays include electron beams, α-rays, β-rays, γ-rays, and X-rays, in addition to ultraviolet rays. When a light source having a particularly high energy is used, polymerization reaction can be allowed to proceed without a polymerization initiator. In addition, in the case of irradiation with ultraviolet ray, mercury-free is preferred in terms of protection of environment. Therefore, replacement with GaN-based semiconductor ultraviolet light-emitting devices is preferred from industrial and environmental point of view. Furthermore, ultraviolet light-emitting diode (UV-LED) and ultraviolet laser diode (UV-LD) are preferable as an ultraviolet light source. Small sizes, long time working life, high efficiency, and high cost performance make such irradiation sources desirable.

### <Polymerization Initiator>

An active-energy-ray-curable composition of the present disclosure may include a polymerization initiator. The polymerization initiator may be a substance that can generate active species (e.g., radicals and cations) by energy of active energy rays to initiate polymerization of polymerizable compounds (e.g., monomers and oligomers). Preferable examples of the polymerization initiator include known radical polymerization initiators, known cationic polymerization initiators, and known base generating agents. These may be used alone or in combination. Among them, radical polymerization initiators are preferably used. An amount of the polymerization initiator is preferably from 4% by mass through 20% by mass relative to the total amount of the active-energy-ray-curable composition. In this case, the surface of the obtained cured material is preferably improved in scratch hardness.

Examples of the radical polymerization initiator include aromatic ketones, acylphosphine oxide compounds, aromatic onium salt compounds, organic peroxides, thio compounds (e.g., thioxanthone compounds and thiophenyl-group-including compounds), hexaaryl biimidazole compounds, ketoxime ester compounds, borate compounds, azinium compounds, metallocene compounds, active ester compounds, compounds including carbon-halogen bonds, and alkylamine compounds.

In addition to the above, α-hydroxyketone-based initiators are exemplified as the polymerization initiator.

Use of the α-hydroxyketone-based initiators is preferable because of achievement of increased scratch hardness on the surface of the cured material. Examples of the α-hydroxyketone-based initiators include hydroxy-cyclohexyl-phenyl-ketone and 2,4,6-trimethylbenzoyl-diphenyl-phosphine oxide.

In addition to the above polymerization initiators, a polymerization accelerator (a sensitizer) can be used in combination. Preferable examples of the polymerization accelerator include, but are not limited to, amine compounds such as trimethylamine, methyldimethanolamine, triethanolamine, p-diethylaminoacetophenone, methyl p-dimethylamino benzoate, ethyl p-dimethylamino benzoate, benzoic acid-2-dimethylaminoethyl, butoxyethyl p-dimethylamino benzoate, p-dimethylamino benzoic acid-2-ethylhexyl, N,N-dimethylbenzylamine, and 4,4′-bis(diethylamino)benzophenone. An amount of the polymerization accelerator may be adjusted depending on the kind and the amount of the polymerization initiator to be used.

### <Colorant>

The composition of the present disclosure may contain a colorant. As the colorant, various pigments and dyes may be used that impart black, white, magenta, cyan, yellow, green, orange, and gloss colors such as gold and silver, depending on the intended purpose of the composition and requisite properties thereof. A content of the colorant in the composition is not particularly limited, and may be appropriately determined considering, for example, a desired color density and dispersibility of the colorant in the composition. However, it is preferably from 0.1% by mass to 20% by mass relative to the total mass (100% by mass) of the composition. Incidentally, the active-energy-ray-curable composition of the present disclosure does not necessarily contain a colorant but can be clear and colorless. In such a case, for example, such a clear and colorless composition is good for an overcoating layer to protect an image.

The pigment can be either inorganic or organic, and two or more of the pigments can be used in combination.

Specific examples of the inorganic pigments include, but are not limited to, carbon blacks (C.I. Pigment Black 7) such as furnace black, lamp black, acetylene black, and channel black, iron oxides, and titanium oxides.

Specific examples of the organic pigments include, but are not limited to, azo pigments such as insoluble azo pigments, condensed azo pigments, azo lakes, and chelate azo pigments, polycyclic pigments such as phthalocyanine pigments, perylene pigments, perinone pigments, anthraquinone pigments, quinacridone pigments, dioxazine pigments, thioindigo pigments, isoindolinone pigments, and quinofuranone pigments, dye chelates (e.g., basic dye chelates, acid dye chelates), dye lakes (e.g., basic dye lakes, acid dye lakes), nitro pigments, nitroso pigments, aniline black, and daylight fluorescent pigments.

In addition, a dispersant is optionally added to enhance the dispersibility of pigment. The dispersant has no particular limit and can be, for example, polymer dispersants conventionally used to prepare pigment dispersion (material).

The dyes include, for example, acidic dyes, direct dyes, reactive dyes, basic dyes, and combinations thereof.

### <Organic Solvent>

The active-energy-ray-curable composition of the present disclosure optionally contains an organic solvent although it is preferable to spare it. The curable composition free of an organic solvent, in particular volatile organic compound (VOC), is preferable because it enhances safety at where the composition is handled and makes it possible to prevent pollution of the environment. Incidentally, the organic solvent represents a conventional non-reactive organic solvent, for example, ether, ketone, xylene, ethyl acetate, cyclohexanone, and toluene, which is clearly distinguished from reactive monomers. Furthermore, “free of” an organic solvent means that no organic solvent is substantially contained. The content thereof is preferably less than 0.1 percent by mass.

### <Other Components>

The active-energy-ray-curable composition of the present disclosure optionally contains other known components. The other known components are not particularly limited. Specific examples thereof include, but are not limited to, known articles such as active silica particles, surfactants, polymerization inhibitors, leveling agents, defoaming agents, fluorescent brighteners, permeation enhancing agents, wetting agents (humectants), fixing agents, viscosity stabilizers, fungicides, preservatives, antioxidants, ultraviolet absorbents, chelate agents, pH adjusters, (regulators), and thickeners.

The active-energy-ray-curable composition of the present disclosure preferably includes active silica particles. When the active-energy-ray-curable composition includes active silica particles, the surface of the cured material can be improved in scratch hardness. An amount of the active silica particles is preferably 0.1% by mass or more but 10.0% by mass or less relative to the total amount of the active-energy-ray-curable composition.

### <Viscosity>

The viscosity of the active-energy-ray-curable composition of the present disclosure has no particular limit because it can be adjusted depending on the purpose and application devices. For example, if an ejecting device that ejects the composition from nozzles is employed, the viscosity thereof is preferably in the range of 3 mPa·s to 40 mPa·s, more preferably 5 mPa·s to 15 mPa·s, and particularly preferably 6 mPa·s to 12 mPa·s in the temperature range of 20 degrees C. to 65 degrees C., preferably at 25 degrees C. In addition, it is particularly preferable to satisfy this viscosity range by the composition free of the organic solvent described above. Incidentally, the viscosity can be measured by a cone plate rotary viscometer (VISCOMETER TVE-22L, manufactured by TOM SANGYO CO., LTD.) using a cone rotor (1° 34′×R24) at a number of rotation of 50 rpm with a setting of the temperature of hemathermal circulating water in the range of 20 degrees C. to 65 degrees C. VISCOMATE VM-150III can be used for the temperature adjustment of the circulating water.

### <Application Field>

The application field of the active-energy-ray-curable composition of the present disclosure is not particularly limited. It can be applied to any field where active-energy-ray-curable compositions are used. For example, the curable composition is selected to a particular application and used for a resin for processing, a paint, an adhesive, an insulant, a releasing agent, a coating material, a sealing material, various resists, and various optical materials.

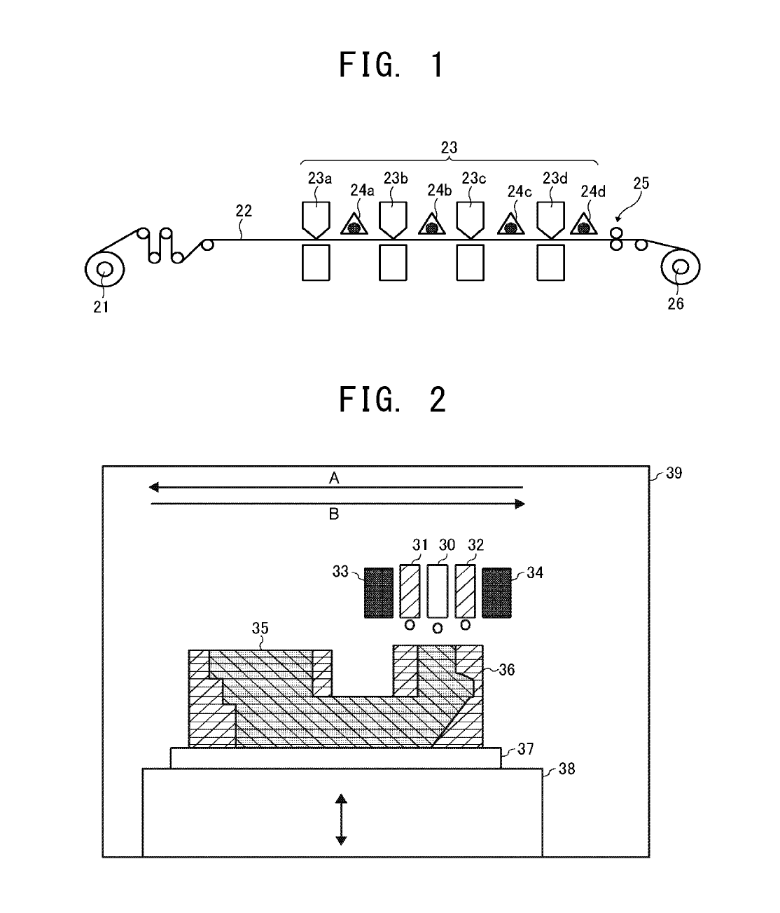

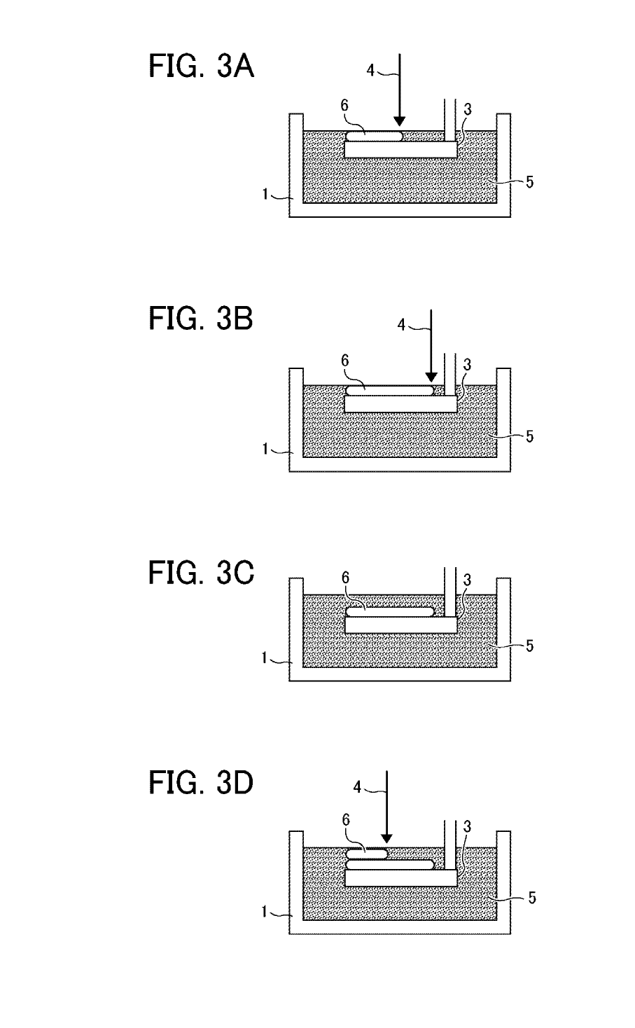

Furthermore, the active-energy-ray-curable composition of the present disclosure can be used as an ink to form two-dimensional texts, images, and designed coating film on various substrates and in addition as a solid object forming material to form a three-dimensional object. This three dimensional object forming material may also be used as a binder for powder particles used in a powder layer laminating method of forming a three-dimensional object by repeating curing and layer-forming of powder layers, and as a three-dimensional object constituent material (a model material) and a supporting member used in an additive manufacturing method (a stereolithography method) as illustrated in FIG. 2, FIG. 3A, FIG. 3B, FIG. 3C, and FIG. 3D. FIG. 2 is a diagram illustrating a method of additive manufacturing to sequentially form layers of the active-energy-ray-curable composition of the present disclosure one on top of the other by repeating discharging the curable composition to particular areas followed by curing upon irradiation of an active energy ray. FIGS. 3A to 3D are each a diagram illustrating a method of additive manufacturing to sequentially form cured layers 6 having respective predetermined forms one on top of the other on a movable stage 3 by irradiating a storing pool (storing part) 1 of the active energy ray curable composition 5 of the present disclosure with the active energy ray 4.

An apparatus for fabricating a three-dimensional object by the active-energy-ray-curable composition of the present disclosure is not particularly limited and can be a known apparatus. For example, the apparatus includes a containing device, a supplying device, and a discharging device of the curable composition, and an active energy ray irradiator.

In addition, the present disclosure includes cured materials obtained by curing the active-energy-ray-curable composition and processed products obtained by processing structures having the cured materials on a substrate. The processed product is fabricated by, for example, heat-drawing and punching a cured material or structure having a sheet-like form or film-like form. Examples thereof are gauges or operation panels of vehicles, office machines, electric and electronic machines, and cameras.

The substrate is not particularly limited. It can suitably be selected to a particular application. Examples thereof include paper, thread, fiber, fabrics, leather, metal, plastic, glass, wood, ceramic, or composite materials thereof. Of these, plastic substrates are preferred in terms of processability.

### (Cured Material and Processed Product)

A cured material of the present disclosure is obtained by curing the active-energy-ray-curable composition of the present disclosure, and includes an image formed by the above method. Moreover, the cured material also includes a three-dimensional object. Note that, the cured material can be formed by printing the active-energy-ray-curable composition on, for example, a medium to be printed (substrate) by the inkjet printing method to form a coated film, and by curing the coated film through photopolymerization.

In use of the active-energy-ray-curable composition of the present disclosure, an image obtained by the below-described device for forming the cured material is irradiated with ultraviolet rays. As a result, the coated film on the medium to be printed is rapidly cured to obtain a cured material.

The present disclosure includes a processed product obtained by processing the cured material formed as described above. The processed product can be obtained by subjecting the cured material to heat stretching and molding process on a medium to be printed. Here, the stretching process means pulling a material under heating for stretching to mold the material into a certain shape, or simply stretching the material.

### (Composition Stored Container)

The composition stored container of the present disclosure contains the active-energy-ray-curable composition and is suitable for the applications as described above. For example, if the active-energy-ray-curable composition of the present disclosure is used for ink, a container that stores the ink can be used as an ink cartridge or an ink bottle. Therefore, users can avoid direct contact with the ink during operations such as transfer or replacement of the ink, so that fingers and clothes are prevented from contamination. Furthermore, inclusion of foreign matters such as dust in the ink can be prevented. In addition, the container can be of any size, any form, and any material. For example, the container can be designed to a particular application. It is preferable to use a light blocking material to block the light or cover a container with a light blocking sheet, etc.

### (Image Forming Method and Image Forming Apparatus)

The image forming method of the present disclosure includes at least an irradiating step of irradiating the curable composition of the present disclosure with an active energy ray to cure the curable composition. The image forming apparatus of the present disclosure includes at least an irradiator to irradiate the curable composition of the present disclosure with an active energy ray and a storing part containing the active-energy-ray-curable composition of the present disclosure. The storing part may include the container mentioned above. Furthermore, the method and the apparatus may respectively include a discharging step and a discharging device to discharge the active energy ray curable composition. The method of discharging the curable composition is not particularly limited, and examples thereof include a continuous jetting method and an on-demand method. The on-demand method includes a piezo method, a thermal method, an electrostatic method, etc.

FIG. 1 is a diagram illustrating a two-dimensional image forming apparatus equipped with an inkjet discharging device. Printing units 23a, 23b, 23c, and 23d respectively having ink cartridges and discharging heads for yellow, magenta, cyan, and black active-energy-ray-curable inks discharge the inks onto a recording medium 22 fed from a supplying roller 21. Thereafter, light sources 24a, 24b, 24c, and 24d configured to cure the inks emit active energy rays to the inks, thereby curing the inks to form a color image. Thereafter, the recording medium 22 is conveyed to a processing unit 25 and a printed matter reeling roll 26. Each of the printing unit 23a, 23b, 23c and 23d may have a heating mechanism to liquidize the ink at the ink discharging portion. Moreover, in another embodiment of the present disclosure, a mechanism may optionally be included to cool down the recording medium to around room temperature in a contact or non-contact manner. In addition, the inkjet recording method may be either of serial methods or line methods.

The serial methods include discharging an ink onto a recording medium by moving the head while the recording medium intermittently moves according to the width of a discharging head. The line methods include discharging an ink onto a recording medium from a discharging head held at a fixed position while the recording medium continuously moves.

The recording medium 22 is not particularly limited. Specific examples thereof include, but are not limited to, paper, film, metal, or complex materials thereof. The recording medium 22 takes a sheet-like form but is not limited thereto. The image forming apparatus may have a one-side printing configuration and/or a two-side printing configuration.

Optionally, multiple colors can be printed with no or weak active energy ray from the light sources 24a, 24b, and 24c followed by irradiation of the active energy ray from the light source 24d. As a result, energy and cost can be saved.

The recorded matter having images printed with the ink of the present disclosure includes articles having printed images or texts on a plain surface of conventional paper, resin film, etc., a rough surface, or a surface made of various materials such as metal or ceramic. In addition, by laminating layers of images in part or the entire of a recording medium, a partially stereoscopic image (formed of two dimensional part and three-dimensional part) and a three dimensional objects can be fabricated.

FIG. 2 is a schematic diagram illustrating another example of the image forming apparatus (apparatus to fabricate a 3D object) of the present disclosure. An image forming apparatus 39 illustrated in FIG. 2 sequentially forms thin layers one on top of the other using a head unit having inkjet heads arranged movable in the directions indicated by the arrows A and B. In the image forming apparatus 39, an ejection head unit 30 for additive manufacturing ejects a first active-energy-ray-curable composition, and ejection head units 31 and 32 for support and curing these compositions ejects a second active-energy-ray-curable composition having a different composition from the first active-energy-ray-curable composition, while ultraviolet irradiators 33 and 34 adjacent to the ejection head units 31 and 32 cure the compositions. To be more specific, for example, after the ejection head units 31 and 32 for support eject the second active-energy-ray-curable composition onto a substrate 37 for additive manufacturing and the second active-energy-ray-curable composition is solidified by irradiation of an active energy ray to form a first substrate layer having a space for composition, the ejection head unit 30 for additive manufacturing ejects the first active-energy-ray-curable composition onto the pool followed by irradiation of an active energy ray for solidification, thereby forming a first additive manufacturing layer. This step is repeated multiple times lowering the stage 38 movable in the vertical direction to laminate the supporting layer (or support layer) and the additive manufacturing layer to fabricate a solid object 35. Thereafter, an additive manufacturing support 36 is removed, if desired. Although only a single ejection head unit 30 for additive manufacturing is provided to the image forming apparatus illustrated 39 in FIG. 2, it can have two or more units 30.

### EXAMPLES

The present disclosure will be described by way of the following Examples. However, the present disclosure should not be construed as being limited to these Examples. Note that, “part(s)” means “part(s) by mass” unless otherwise specified and “%” means “% by mass” unless otherwise specified.

### (Materials)

Materials used in the following Examples and Comparative Examples are as follows.

### <Monofunctional Monomer>

Tetrahydrofurfuryl acrylate: THFA (available from Osaka Organic Chemical Industry Ltd.)

Isobornyl acrylate: IBXA (available from Osaka Organic Chemical Industry Ltd.)

Phenoxyethyl acrylate: PEA (available from Osaka Organic Chemical Industry Ltd.)

N-vinylcaprolactam: NVC (available from Osaka Organic Chemical Industry Ltd.)

1-Adamantyl acrylate: 1-AdA (available from Osaka Organic Chemical Industry Ltd.)

Isooctyl acrylate: IOA (available from Osaka Organic Chemical Industry Ltd.)

Stearyl acrylate: STA (available from Osaka Organic Chemical Industry Ltd.)

Ethyl acrylate: EA (available from Mitsubishi Chemical Corporation)

Acryloyl morpholine: ACMO (available from KJ Chemicals Corporation)

### <Multifunctional Monomer>

1,3-Butylene glycol diacrylate: SR212 (available from Sartomer CO.)

1,6-Hexanediol diacrylate: A-HD-N (available from Shin Nakamura Chemical Co., Ltd.)

### <Oligomer>

Polyester urethane acrylate oligomer: SHIKOH UV-3010B (available from The Nippon Synthetic Chemical Industry Co., Ltd.)

### <Non-Polymerizable Resin>

### —Synthesis of Non-Polymerizable Resin 1—

A flask (1 L) equipped with a condenser tube, a stirrer, a gas introducing tube, and a thermometer was charged with ion-exchanged water (100 g) and propylene glycol monomethyl ether (5 g), and the resultant mixture was stirred. To the above mixture, a monomer mixture of styrene (60 g) and acrylic acid-n-butyl (5 g), di-t-butyl peroxide (1 g) as a polymerization initiator, divinylbenzene (0.3 g) as a cross-linking agent, and sodium dodecylbenzenesulfonate (1 g) were added dropwise under stirring. The resultant mixture was heated to 90° C. and was allowed to react for 12 hours. The obtained polymerized product was washed with water and then cooled to 10° C. in an ice bath. Then, the polymerized product was filtrated using a KIRIYAMA filter paper (No. 5C) and the filtrate was dried at normal temperature and 10 torr.

A value of the thermal property TP was 85° C.

### —Synthesis of Non-Polymerizable Resin 2—

A flask (1 L) equipped with a condenser tube, a stirrer, a gas introducing tube, and a thermometer was charged with ion-exchanged water (100 g), styrene (20 g), methacrylic acid (16 g), sodium alkyl allyl sulfosuccinate (ELEMINOL JS-2, available from Sanyo Chemical Industries, Ltd.) (3 g), and ammonium persulfate (0.2 g), and the resultant mixture was stirred for 20 minutes. The obtained mixture was heated to 75° C. and was allowed to react for 6 hours. Then, 1% ammonium persulfate aqueous mixture (8 g) was further added to the mixture and was stirred at 75° C. for 6 hours. Then, the mixture was cooled to 10° C. in an ice bath. The obtained product was filtrated using a KIRIYAMA filter paper (No. 5C) and the filtrate was dried at normal temperature and 10 torr.

A value of the thermal property TP was 73° C.

### —Synthesis of Non-Polymerizable Resin 3—

A reaction container equipped with a condenser tube, a stirrer, and a nitrogen introducing tube was charged with bisphenol A propylene oxide 2 mole adduct (450 parts), bisphenol A propylene oxide 3 mole adduct (280 parts), terephthalic acid (257 parts), isophthalic acid (65 parts), maleic anhydride (10 parts), and titanium dihydroxybis(triethanolaminato) (2 parts) as a condensation catalyst. The resultant mixture was allowed to react for 10 hours while water generated was removed under a nitrogen stream at 220° C. Next, the resultant mixture was allowed to react under the reduced pressure of from 5 mmHg through 20 mmHg, and was taken out at a time when the acid value reached 8 KOH mg/g. The mixture was cooled to room temperature and was pulverized.

A value of the thermal property TP was 122° C.

### —Synthesis of Non-Polymerizable Resin 4—

A flask equipped with a Hempel distilling tube, a thermometer, and a nitrogen introducing tube was charged with diphenyl carbonate (200 parts) and 1,6-hexanediol (200 parts by mass). Under a nitrogen gas atmosphere, the inside of the flask was adjusted to 150° C. and a reduced pressure of 200 torr, followed by reflux for 30 minutes. Next, a degree of the reduced pressure was increased to 100 torr, and the resultant mixture continued to be heated for 30 minutes. The degree of the reduced pressure was further increased to 5 torr, and 1,6-hexanediol was removed to obtain polycarbonate polyol. Next, isophorone diisocyanate (35 parts) was added to a mixture of polycarbonate polyol (150 parts) and 1,3-butanediol (2 parts), and then the resultant mixture was allowed to react for 2 hours at room temperature. Then, isophorone diamine (12 parts) was gradually added dropwise to the mixture. Then, the resultant mixture was dried at normal temperature and 10 torr.

A value of the thermal property TP was 104° C.

### <Polymerization Initiator>

Hydroxy-cyclohexyl-phenyl-ketone: IRGACURE 184 (available from BASF)

2-Hydroxy-1-{4-[4-(2-hydroxy-2-methyl-propionyl)-benzyl]phenyl}-2-meth yl-propan-1-one: IRGACURE 127 (available from BASF)

2,4,6-Trimethylbenzoyl-diphenyl-phosphine oxide: LUCIRIN TPO (available from BASF)

2,4-Diethylthioxanthone: KAYACURE-DETX-S (available from Nippon Kayaku Co., Ltd.)

### <Colorant>

### Cyan Pigment

An amount of the cyan pigment presented was an amount of a mixture containing a polymeric dispersant (S32000, available from The Lubrizol Corporation) and phthalocyanine blue (available from SANYO COLOR WORKS, Ltd.) at a mass ratio of 3:1 (polymeric dispersant:phthalocyanine blue).

### Black Pigment

An amount of the black pigment presented was an amount of a mixture containing a polymeric dispersant (S32000, available from The Lubrizol Corporation) and carbon black #10 (available from Mitsubishi Chemical Corporation) at a mass ratio of 3:1 (polymeric dispersant:carbon black #10).

### Magenta Pigment

An amount of the magenta pigment presented was an amount of a mixture containing a polymeric dispersant (S32000, available from The Lubrizol Corporation) and CINQUASIA MAGENTA L 4540 (available from BASF) at a mass ratio of 3:1 (polymeric dispersant:CINQUASIA MAGENTA L 4540).

### <Silica Particles>

SFP-20M (Denka Company Limited)

### Examples 1 to 29

Based on the following Table 1, active-energy-ray-curable compositions were prepared. Here, each numerical value of Table 1 means an amount of a material added, the amount being represented by “parts by mass”.

The materials were added sequentially in the order of from the left to the right of Table 1 under stirring. After stirring of the materials for 1 hour, it was confirmed that there was not any material that remained undissolved. Then, the resultant solution was filtrated through a membrane filter, and coarse particles causing a head clogging were removed to obtain [active-energy-ray-curable composition 1] to [active-energy-ray-curable composition 29].

### Comparative Examples 1 to 11

In the same manner as in the above Examples except that the amounts of the materials added were changed to the amounts of the materials presented in Table 2, [active-energy-ray-curable composition 30] to [active-energy-ray-curable composition 40] were obtained.

### (Measurement Items)

### <Preparation of Cured Material>

In order to perform the following measurements and evaluations, cured materials of the active-energy-ray-curable compositions were prepared.

Each of the active-energy-ray-curable compositions was coated on a glass slide (available from Artec Co., Ltd., 008534, 26×76 mm, thickness: from 1 mm through 1.2 mm) so as to have a film thickness of 10 Immediately after the coating, the active-energy-ray-curable composition was irradiated with ultraviolet rays (illuminance: 1.5 W/cm², light quantity: 200 mJ/cm²) by an UV irradiator LH6 (available from Fusion Systems Japan) to obtain a cured material.

### <Variable Normal Load Friction and Wear Measurement System>

The cured material of the active-energy-ray-curable composition was used to determine the W1 and the W2 according to the above-described method. The measurement conditions are given below.

Device: HEIDON (available from Shinto Scientific Co., Ltd.), a variable normal load friction and wear measurement system TYPE HHS2000

Indenter: Sapphire stylus, 0.2 mm R 60 degrees

Friction distance: 25 mm

Friction speed: 0.5 mm/sec

Continuous loading: From 0 g through 200 g

Number of measurements: Measured twice at different positions

Loading converter (friction): 19.61 N (2,000 gf) . . . 5,000 mV=2,000 gf

PC data acquisition: 10 msec×5,000 data=50 sec

### <Thermal Property TP>

The thermal property TP of the non-polymerizable resin was determined in the following manner.

### [Measurement Conditions]

Device: Flow tester CFT-500D (available from SHIMADZU CORPORATION)

Sample: A sample (1 g) was pressure-molded into a cylindrical tablet having a diameter of 1 cm for use.

Temperature conditions: The sample was heated from 50° C. at a heating rate of 3° C./min to a temperature at which flow-out of the sample was completed.

Load: 10 kg

Hole diameter of die: 0.5 mm

Length of die: 1.0 mm

Remaining heat time: 200 s

As presented in FIG. 8, in the device, a resin sample 20 that had been molded into the tablet in a cylinder 16 was heated with a heating member 18, while a load was applied with a plunger 14. Then, the melted resin (melted and flown-out resin 10) was allowed to flow out from a the hole (nozzle 12). A descending amount of the plunger 14 was measured and evaluated for viscoelasticity (temperature dependency) of the resin. From the obtained graph, a middle temperature between the flowing-out beginning temperature Tfb and the Tend ((Tfb+Tend)/2) was determined to obtain the TP.

### (Evaluation Items)

### <(1) Scratch Hardness Test>

The obtained material was used to perform the test with a pencil (hardness mark: F) according to the JIS K5600-5-4 scratch hardness (the pencil method).

### [Evaluation Criteria]

A: No scratch was found.
B: A scratch was found depending on the observation angle.
C: A shallow scratch was found from all the angles.
D: A deep scratch was found from all the angles.

### <(2) Indentation Hardness Test>

Using a Micro Vickers Hardness Tester, the obtained cured material was evaluated for a trace formed by indentation when an indenter was indented into the sample under the following conditions.

### [Conditions]

Device: MVK-G1 model, available from Akashi Corporation

Indenter: Pyramid-shaped diamond indenter (angle between opposite faces: 136°)

Load: 15 g

Test force duration: 1 second

### [Evaluation Criteria]

A: No trace formed by indentation was found.
B: A trace formed by indentation was found, but a shape of the indenter (rectangle) was not found in the trace formed by indentation.
C: A trace formed by indentation was found, and a shape of the indenter (rectangle) was found in the trace formed by indentation; however, the trace formed by indentation did not reach the glass slide substrate.
D: A trace formed by indentation was found, and a shape of the indenter (rectangle) was found in the trace formed by indentation; moreover, the trace formed by indentation reached the glass slide substrate.

### <(3) Close Adhesiveness Test>

The obtained cured material was evaluated for close adhesiveness according to the cross-cut adhesion test of JIS K5400 (old standard). Here, the close adhesiveness being 100 means that none of the cross-cut portions, which have been obtained by cutting the cured material into 100 pieces, ianot peeled. The close adhesiveness being 80 means that the total area of the non-peeled portions is 80% relative to the entire area.

### [Evaluation Criteria]

A: Close adhesiveness was 95 or more but 100 or less
B: Close adhesiveness was 90 or more but less than 95
C: Close adhesiveness was 80 or more but less than 90
D: Close adhesiveness was less than 80

Tables 1 and 2 present mixing ratios of the materials for the active-energy-ray-curable compositions of Examples 1 to 29 and Comparative Examples 1 to 11. In addition, the measurement results and the evaluation results obtained by the above variable normal load friction and wear measurement system are presented in Table 3. Here, in Tables 1 to 3, “Composition No.” means “active-energy-ray-curable composition No.”

TABLE 1

| | | Monomers | | | | | | | | | | |
|---|---|---|---|---|---|---|---|---|---|---|---|---|
| Examples/ | | Monofunctional | | | | | | | | | Multifunctional | |
| Comparative | Composition | monomers | | | | | | | | | monomers | |
| Examples | Nos. | THFA | IBXA | PEA | NVC | 1-AdA | IOA | STA | EA | ACMO | SR212 | A-HD-N |
| Example 1 | 1 | 100 | 0 | 0 | 0 | 0 | 00 | 0 | 0 | 0 | 0 | 0 |
| Example 2 | 2 | 100 | 0 | 0 | 0 | 0 | 0 | 0 | 0 | 0 | 10 | 0 |
| Example 3 | 3 | 100 | 0 | 0 | 0 | 0 | 0 | 0 | 0 | 0 | 20 | 0 |
| Example 4 | 4 | 100 | 0 | 0 | 0 | 0 | 0 | 0 | 0 | 0 | 20 | 0 |
| Example 5 | 5 | 100 | 0 | 0 | 0 | 0 | 0 | 0 | 0 | 0 | 20 | 0 |
| Example 6 | 6 | 100 | 0 | 0 | 0 | 0 | 0 | 0 | 0 | 0 | 20 | 0 |
| Example 7 | 7 | 100 | 0 | 0 | 0 | 0 | 0 | 0 | 0 | 0 | 20 | 0 |
| Example 8 | 8 | 100 | 0 | 0 | 0 | 0 | 0 | 0 | 0 | 0 | 20 | 0 |
| Example 9 | 9 | 100 | 0 | 0 | 0 | 0 | 0 | 0 | 0 | 0 | 20 | 0 |
| Example 10 | 10 | 100 | 0 | 0 | 0 | 0 | 0 | 0 | 0 | 0 | 20 | 0 |
| Example 11 | 11 | 100 | 0 | 0 | 0 | 0 | 0 | 0 | 0 | 0 | 20 | 0 |
| Example 12 | 12 | 100 | 0 | 0 | 0 | 0 | 0 | 0 | 0 | 0 | 0 | 0 |
| Example 13 | 13 | 100 | 0 | 0 | 0 | 0 | 0 | 0 | 0 | 0 | 10 | 0 |
| Example 14 | 14 | 100 | 0 | 0 | 0 | 0 | 0 | 0 | 0 | 0 | 10 | 0 |
| Example 15 | 15 | 100 | 0 | 0 | 0 | 0 | 0 | 0 | 0 | 0 | 10 | 0 |
| Example 16 | 16 | 100 | 0 | 0 | 0 | 0 | 0 | 0 | 0 | 0 | 10 | 0 |
| Example 17 | 17 | 100 | 0 | 0 | 0 | 0 | 0 | 0 | 0 | 0 | 20 | 0 |
| Example 18 | 18 | 100 | 0 | 0 | 0 | 0 | 0 | 0 | 0 | 0 | 20 | 0 |
| Example 19 | 19 | 100 | 0 | 0 | 0 | 0 | 0 | 0 | 0 | 0 | 20 | 0 |
| Example 20 | 20 | 100 | 0 | 0 | 0 | 0 | 0 | 0 | 0 | 0 | 20 | 0 |
| Example 21 | 21 | 100 | 0 | 0 | 0 | 0 | 0 | 0 | 0 | 0 | 20 | 0 |
| Example 22 | 22 | 100 | 0 | 0 | 0 | 0 | 0 | 0 | 0 | 0 | 20 | 0 |
| Example 23 | 23 | 100 | 0 | 0 | 0 | 0 | 0 | 0 | 0 | 0 | 20 | 0 |
| Example 24 | 24 | 100 | 0 | 0 | 0 | 0 | 0 | 0 | 0 | 0 | 20 | 0 |
| Example 25 | 25 | 25 | 25 | 25 | 25 | 0 | 0 | 0 | 0 | 0 | 20 | 0 |
| Example 26 | 26 | 0 | 40 | 0 | 40 | 20 | 0 | 0 | 0 | 0 | 20 | 0 |
| Example 27 | 27 | 0 | 25 | 25 | 50 | 0 | 0 | 0 | 0 | 0 | 20 | 0 |
| Example 28 | 28 | 0 | 0 | 25 | 0 | 0 | 25 | 50 | 0 | 0 | 0 | 20 |
| Example 29 | 29 | 0 | 50 | 0 | 0 | 30 | 0 | 0 | 10 | 10 | 20 | 0 |

| | | Non-polymerizable | | | | | | | | |
|---|---|---|---|---|---|---|---|---|---|---|
| Examples/ | | resins | | Initiators | | | | Pigments | | |
| Comparative | Oligomer | Resin names/ | | IRGACURE | IRGACURE | LICIRIN | | Kinds/ | | Silica |
| Examples | UV3010B | amounts | | 184 | 127 | TPO | DETX | amounts | | particles |
| Example 1 | 0 | Non-polymerizable | 5 | 7.5 | 0 | 0 | 0 | Cyan | 5 | 0 |
| | | resin 1 | | | | | | | | |
| Example 2 | 0 | Non-polymerizable | 5 | 7.5 | 0 | 0 | 0 | Cyan | 5 | 0 |
| | | resin 1 | | | | | | | | |
| Example 3 | 0 | Non-polymerizable | 5 | 7.5 | 0 | 0 | 0 | Cyan | 5 | 0 |
| | | resin 1 | | | | | | | | |
| Example 4 | 5 | Non-polymerizable | 5 | 7.5 | 0 | 0 | 0 | Cyan | 5 | 0 |
| | | resin 1 | | | | | | | | |
| Example 5 | 15 | Non-polymerizable | 5 | 7.5 | 0 | 0 | 0 | Cyan | 5 | 0 |
| | | resin 1 | | | | | | | | |
| Example 6 | 15 | Non-polymerizable | 5 | 5 | 2.5 | 0 | 0 | Cyan | 5 | 0 |
| | | resin 1 | | | | | | | | |
| Example 7 | 5 | Non-polymerizable | 5 | 5 | 2.5 | 0 | 0 | Cyan | 5 | 0 |
| | | resin 1 | | | | | | | | |
| Example 8 | 0 | Non-polmerizable | 5 | 5 | 2.5 | 0 | 0 | Cyan | 5 | 0 |
| | | resin 1 | | | | | | | | |
| Example 9 | 15 | Non-polymerizable | 5 | 2.5 | 5 | 0 | 0 | Cyan | 5 | 0 |
| | | resin 1 | | | | | | | | |
| Example 10 | 5 | Non-polymerizable | 5 | 2.5 | 5 | 0 | 0 | Cyan | 5 | 0 |
| | | resin 1 | | | | | | | | |
| Example 11 | 0 | Non-polymerizable | 5 | 2.5 | 5 | 0 | 0 | Cyan | 5 | 0 |
| | | resin 1 | | | | | | | | |
| Example 12 | 0 | Non-polymerizable | 5 | 7.5 | 0 | 0 | 0 | Cyan | 5 | 0 |
| | | resin 2 | | | | | | | | |
| Example 13 | 0 | Non-polymerizable | 5 | 7.5 | 0 | 0 | 0 | Cyan | 5 | 0 |
| | | resin 2 | | | | | | | | |
| Example 14 | 10 | Non-polymerizable | 5 | 7.5 | 0 | 0 | 0 | Cyan | 5 | 0 |
| | | resin 2 | | | | | | | | |
| Example 15 | 10 | Non-polymerizable | 5 | 7.5 | 0 | 0 | 0 | Cyan | 5 | 3 |
| | | resin 2 | | | | | | | | |
| Example 16 | 0 | Non-polymerizable | 5 | 7.5 | 0 | 0 | 0 | Cyan | 5 | 3 |
| | | resin 2 | | | | | | | | |
| Example 17 | 5 | Non-polymerizable | 15 | 5 | 2.5 | 0 | 0 | Cyan | 5 | 0 |
| | | resin 1 | | | | | | | | |
| Example 18 | 5 | Non-polymerizable | 10 | 5 | 2.5 | 0 | 0 | Cyan | 5 | 0 |
| | | resin 1 | | | | | | | | |
| Example 19 | 5 | Non-polymerizable | 3 | 5 | 2.5 | 0 | 0 | Cyan | 5 | 0 |
| | | resin 1 | | | | | | | | |
| Example 20 | 5 | Non-polymerizable | 1 | 5 | 2.5 | 0 | 0 | Cyan | 5 | 0 |
| | | resin 1 | | | | | | | | |
| Example 21 | 5 | Non-polymerizable | 5 | 5 | 2.5 | 0 | 0 | Black | 5 | 0 |
| | | resin 1 | | | | | | | | |
| Example 22 | 5 | Non-polymerizable | 5 | 5 | 2.5 | 0 | 0 | Magenta | 5 | 0 |
| | | resin 1 | | | | | | | | |
| Example 23 | 5 | Non-polymerizable | 5 | 5 | 2.5 | 0 | 0 | Cyan | 10 | 0 |
| | | resin 1 | | | | | | | | |
| Example 24 | 5 | Non-polymerizable | 5 | 5 | 2.5 | 0 | 0 | — | 0 | 0 |
| | | resin 1 | | | | | | | | |
| Example 25 | 5 | Non-polymerizable | 5 | 5 | 2.5 | 0 | 0 | Cyan | 5 | 0 |
| | | resin 1 | | | | | | | | |
| Example 26 | 5 | Non-polymerizable | 5 | 5 | 2.5 | 0 | 0 | Cyan | 5 | 0 |
| | | resin 1 | | | | | | | | |
| Example 27 | 5 | Non-polymerizable | 5 | 5 | 2.5 | 0 | 0 | Cyan | 5 | 0 |
| | | resin 1 | | | | | | | | |
| Example 28 | 5 | Non-polymerizable | 5 | 5 | 2.5 | 0 | 0 | Cyan | 5 | 0 |
| | | resin 1 | | | | | | | | |
| Example 29 | 5 | Non-polymerizable | 5 | 5 | 2.5 | 0 | 0 | Cyan | 5 | 0 |
| | | resin 1 | | | | | | | | |

TABLE 2

| | | Monomers | |
|---|---|---|---|
| Examples/ | | Monofunctional | Multifunctional |
| Comparative | Composition | monomers | monomers |

| Examples | Nos. | THFA | IBXA | PEA | NVC | 1-AdA | IOA | STA | EA | ACMO | SR212 | A-HD-N |
|---|---|---|---|---|---|---|---|---|---|---|---|---|
| Comparative | 30 | 100 | 0 | 0 | 0 | 0 | 0 | 0 | 0 | 0 | 0 | 0 |
| Example 1 | | | | | | | | | | | | |
| Comparative | 31 | 100 | 0 | 0 | 0 | 0 | 0 | 0 | 0 | 0 | 25 | 0 |
| Example 2 | | | | | | | | | | | | |
| Comparative | 32 | 100 | 0 | 0 | 0 | 0 | 0 | 0 | 0 | 0 | 0 | 0 |
| Example 3 | | | | | | | | | | | | |
| Comparative | 33 | 100 | 0 | 0 | 0 | 0 | 0 | 0 | 0 | 0 | 20 | 0 |
| Example 4 | | | | | | | | | | | | |
| Comparative | 34 | 100 | 0 | 0 | 0 | 0 | 0 | 0 | 0 | 0 | 10 | 0 |
| Example 5 | | | | | | | | | | | | |
| Comparative | 35 | 100 | 0 | 0 | 0 | 0 | 0 | 0 | 0 | 0 | 25 | 0 |
| Example 6 | | | | | | | | | | | | |
| Comparative | 36 | 0 | 0 | 0 | 0 | 0 | 0 | 0 | 0 | 0 | 120 | 0 |
| Example 7 | | | | | | | | | | | | |
| Comparative | 37 | 100 | 0 | 0 | 0 | 0 | 0 | 0 | 0 | 0 | 0 | 0 |
| Example 8 | | | | | | | | | | | | |
| Comparative | 38 | 100 | 0 | 0 | 0 | 0 | 0 | 0 | 0 | 0 | 0 | 0 |
| Example 9 | | | | | | | | | | | | |
| Comparative | 39 | 100 | 0 | 0 | 0 | 0 | 0 | 0 | 0 | 0 | 20 | 0 |
| Example 10 | | | | | | | | | | | | |
| Comparative | 40 | 100 | 0 | 0 | 0 | 0 | 0 | 0 | 0 | 0 | 20 | 0 |
| Example 11 | | | | | | | | | | | | |

| | | Non-polymerizable | | | | | | | | |
|---|---|---|---|---|---|---|---|---|---|---|
| Examples/ | | resins | | Initiators | | | | Pigments | | |
| Comparative | Oligomer | Resin names/ | | IRGACURE | IRGACURE | LICIRIN | | Kinds/ | | Silica |
| Examples | UV3010B | amounts | | 184 | 127 | TPO | DETX | amounts | | particles |
| Comparative | 0 | — | 0 | 7.5 | 0 | 0 | 0 | Cyan | 5 | 0 |
| Example 1 | | | | | | | | | | |
| Comparative | 0 | Non-polymerizable | 5 | 7.5 | 0 | 0 | 0 | Cyan | 5 | 0 |
| Example 2 | | resin 1 | | | | | | | | |
| Comparative | 0 | Non-polymerizable | 5 | 4 | 0 | 0 | 0 | Cyan | 5 | 0 |
| Example 3 | | resin 1 | | | | | | | | |
| Comparative | 0 | Non-polymerizable | 5 | 4 | 0 | 0 | 0 | Cyan | 5 | 0 |
| Example 4 | | resin 1 | | | | | | | | |
| Comparative | 15 | Non-polymerizable | 5 | 7.5 | 0 | 0 | 0 | Cyan | 5 | 3 |
| Example 5 | | resin 2 | | | | | | | | |
| Comparative | 5 | Non-polymerizable | 5 | 7.5 | 0 | 0 | 0 | Cyan | 5 | 3 |
| Example 6 | | resin 2 | | | | | | | | |
| Comparative | 0 | Non-polymerizable | 5 | 7.5 | 0 | 0 | 0 | Cyan | 5 | 0 |
| Example 7 | | resin 1 | | | | | | | | |
| Comparative | 0 | Non-polymerizable | 2 | 7.5 | 0 | 5 | 2 | Cyan | 5 | 0 |
| Example 8 | | resin 3 | | | | | | | | |
| Comparative | 0 | Non-polymerizable | 5 | 7.5 | 0 | 10 | 2 | Cyan | 5 | 0 |
| Example 9 | | resin 4 | | | | | | | | |
| Comparative | 5 | Non-polymerizable | 20 | 5 | 2.5 | 0 | 0 | Cyan | 5 | 0 |
| Example 10 | | resin 1 | | | | | | | | |
| Comparative | 5 | Non-polymerizable | 0 | 5 | 2.5 | 0 | 0 | Cyan | 5 | 0 |
| Example 11 | | resin 1 | | | | | | | | |

TABLE 3

| | | Variable normal load | | | | |
|---|---|---|---|---|---|---|
| | | friction and wear | | | Inden- | Close |
| Examples/ | Compo- | measurement system | | Scratch | tation | adhe- |
| Comparative | sition | W1 | W2 | hard- | hard- | sive- |
| Examples | Nos. | (g) | (g) | ness | ness | ness |
| Example 1 | 1 | 75.1 | 299.8 | C | C | A |
| Example 2 | 2 | 80.2 | 245.3 | C | B | B |
| Example 3 | 3 | 95.3 | 166.1 | C | A | C |
| Example 4 | 4 | 92.5 | 250.5 | C | B | B |
| Example 5 | 5 | 90.6 | 285.1 | C | C | A |
| Example 6 | 6 | 120.6 | 300.0 | B | C | A |
| Example 7 | 7 | 125.6 | 245.3 | B | B | B |
| Example 8 | 8 | 130.3 | 168.0 | B | A | C |
| Example 9 | 9 | 141.0 | 295.0 | A | C | A |
| Example 10 | 10 | 145.3 | 240.0 | A | B | B |
| Example 11 | 11 | 146.0 | 190.0 | A | A | C |
| Example 12 | 12 | 100.1 | 285.0 | B | C | A |
| Example 13 | 13 | 118.1 | 201.2 | B | B | B |
| Example 14 | 14 | 115.0 | 255.5 | B | B | B |
| Example 15 | 15 | 179.9 | 257.1 | A | B | B |
| Example 16 | 16 | 181.5 | 202.2 | A | B | B |
| Example 17 | 17 | 136.9 | 165.3 | B | A | C |
| Example 18 | 18 | 134.4 | 204.4 | B | B | B |
| Example 19 | 19 | 115.0 | 270.3 | B | B | B |
| Example 20 | 20 | 110.2 | 297.0 | B | C | A |
| Example 21 | 21 | 125.0 | 245.1 | B | B | B |
| Example 22 | 22 | 124.5 | 244.6 | B | B | B |
| Example 23 | 23 | 128.7 | 246.0 | B | B | B |
| Example 24 | 24 | 124.6 | 242.2 | B | B | B |
| Example 25 | 25 | 101.0 | 202.3 | B | B | B |
| Example 26 | 26 | 139.5 | 278.9 | B | B | B |
| Example 27 | 27 | 90.4 | 295.0 | C | C | A |
| Example 28 | 28 | 80.3 | 210.1 | C | B | B |
| Example 29 | 29 | 145.3 | 203.6 | A | B | B |
| Comparative | 30 | 75.1 | 360.3 | C | D | A |
| Example 1 | | | | | | |
| Comparative | 31 | 80.7 | 150.1 | C | A | D |
| Example 2 | | | | | | |
| Comparative | 32 | 60.9 | 288.8 | D | C | A |
| Example 3 | | | | | | |
| Comparative | 33 | 70.0 | 170.3 | D | A | C |
| Example 4 | | | | | | |
| Comparative | 34 | 170.0 | 302.3 | A | D | A |
| Example 5 | | | | | | |
| Comparative | 35 | 140.1 | 140.1 | A | A | D |
| Example 6 | | | | | | |
| Comparative | 36 | 125.3 | 125.3 | B | A | D |
| Example 7 | | | | | | |
| Comparative | 37 | 142.3 | 148.0 | A | A | D |
| Example 8 | | | | | | |
| Comparative | 38 | 151.1 | 155.9 | A | A | D |
| Example 9 | | | | | | |
| Comparative | 39 | 141.5 | 155.8 | A | A | D |
| Example 10 | | | | | | |
| Comparative | 40 | 90.2 | 345.5 | C | D | A |
| Example 11 | | | | | | |

What is claimed is:

1. An active-energy-ray-curable composition,
wherein a cured material of the active-energy-ray-curable composition satisfies W1 of 75.0 g or more and W2 of 165.0 g or more but 300.0 g or less when the cured material is analyzed by a variable normal load friction and wear measurement system, the W1 being expressed by W1=4*TW1 and the W2 being expressed by W2=4*TW2, the TW1 and the TW2 being obtained by a method in which:
the cured material is formed by coating the active-energy-ray-curable composition on a substrate so as to have a thickness of 10 μm, and by curing the active-energy-ray-curable composition, and
in the variable normal load friction and wear measurement system, a load is applied to the cured material with an indenter while the load is changed from 0 g through 200 g for 50 seconds to obtain a graph having a time in a horizontal axis and a friction resistance force in a vertical axis, and in the graph obtained, a time at which a scratch first occurs in the cured material is defined as T1 and a time closest to the T1 among times at which a change in the friction resistance force is discontinuous is defined as the TW1, and
the TW2 is defined as a time at which the substrate is exposed.

2. The active-energy-ray-curable composition according to claim 1, wherein the active-energy-ray-curable composition includes a non-polymerizable resin.

3. The active-energy-ray-curable composition according to claim 2, wherein a thermal property TP (° C.) of the non-polymerizable resin is 70° C. or more but 130° C. or less.

4. The active-energy-ray-curable composition according to claim 1, wherein the active-energy-ray-curable composition includes a monofunctional monomer including one polymerizable, ethylenically-unsaturated double bond and a polymerization initiator.

5. The active-energy-ray-curable composition according to claim 1, wherein the active-energy-ray-curable composition includes a multifunctional monomer including two or more polymerizable, ethylenically-unsaturated double bonds, and
wherein an amount of the multifunctional monomer is 5% by mass or more but 15% by mass or less relative to a total amount of the active-energy-ray-curable composition.

6. The active-energy-ray-curable composition according to claim 1, wherein the active-energy-ray-curable composition includes a multifunctional monomer including two or more polymerizable, ethylenically-unsaturated double bonds, and
wherein an amount of the multifunctional monomer is 10% by mass or more but 15% by mass or less relative to a total amount of the active-energy-ray-curable composition, and the active-energy-ray-curable composition includes an oligomer including a polymerizable, ethylenically-unsaturated double bond.

7. The active-energy-ray-curable composition according to claim 4, wherein the active-energy-ray-curable composition includes the polymerization initiator in an amount of 4% by mass or more but 20% by mass or less relative to a total amount of the active-energy-ray-curable composition.

8. The active-energy-ray-curable composition according to claim 7, wherein the polymerization initiator includes an α-hydroxyketone-based initiator.

9. The active-energy-ray-curable composition according to claim 1, wherein the active-energy-ray-curable composition includes active silica particles.

10. A cured material,
wherein the cured material is obtained by curing an active-energy-ray-curable composition,
wherein the cured material of the active-energy-ray-curable composition satisfies W1 of 75.0 g or more and W2 of 165.0 g or more but 300.0 g or less when the cured material is analyzed by a variable normal load friction and wear measurement system, the W1 being expressed by W1=4*TW1 and the W2 being expressed by W2=4*TW2, the TW1 and the TW2 being obtained by a method in which:
the cured material is formed by coating the active-energy-ray-curable composition on a substrate so as to have a thickness of 10 μm, and by curing the active-energy-ray-curable composition, and
in the variable normal load friction and wear measurement system, a load is applied to the cured material with an indenter while the load is changed from 0 g through 200 g for 50 seconds to obtain a graph having a time in a horizontal axis and a friction resistance force in a vertical axis, and in the graph obtained, a time at which a scratch first occurs in the cured material is defined as T1 and a time closest to the T1 among times at which a change in the friction resistance force is discontinuous is defined as the TW1, and
the TW2 is defined as a time at which the substrate is exposed.

11. A composition stored container comprising:
an active-energy-ray-curable composition; and
a container including the active-energy-ray-curable composition,
wherein a cured material of the active-energy-ray-curable composition satisfies W1 of 75.0 g or more and W2 of 165.0 g or more but 300.0 g or less when the cured material is analyzed by a variable normal load friction and wear measurement system, the W1 being expressed by W1=4*TW1 and the W2 being expressed by W2=4*TW2, the TW1 and the TW2 being obtained by a method in which:
the cured material is formed by coating the active-energy-ray-curable composition on a substrate so as to have a thickness of 10 μm, and by curing the active-energy-ray-curable composition, and
in the variable normal load friction and wear measurement system, a load is applied to the cured material with an indenter while the load is changed from 0 g through 200 g for 50 seconds to obtain a graph having a time in a horizontal axis and a friction resistance force in a vertical axis, and in the graph obtained, a time at which a scratch first occurs in the cured material is defined as T1 and a time closest to the T1 among times at which a change in the friction resistance force is discontinuous is defined as the TW1, and
the TW2 is defined as a time at which the substrate is exposed.

12. A two-dimensional or three-dimensional image forming apparatus comprising:
a storing part including the active-energy-ray-curable composition according to claim 1; and
an irradiator configured to emit active energy rays.

13. A two-dimensional or three-dimensional image forming method comprising
irradiating the active-energy-ray-curable composition according to claim 1.
